(19) United States
(12) Patent Application Publication
(10) Pub. No.: US 2024/0305208 A1
(43) Pub. Date: Sep. 12, 2024

(54) POWER CONVERTER

(71) Applicant: MICROCHIP TECHNOLOGY INCORPORATED, Chandler, AZ (US)

(72) Inventors: Wensong Yu, Raleigh, NC (US); Dakai Wang, Raleigh, NC (US); Xuning Zhang, Round Rock, TX (US); Greg Mann, Raleigh, NC (US); Steven Chenetz, Chandler, AZ (US); Dennis Meyer, Bend, OR (US); Ehab Tarmoom, Allen Park, MI (US)

(21) Appl. No.: 18/600,119

(22) Filed: Mar. 8, 2024

Related U.S. Application Data
(60) Provisional application No. 63/451,132, filed on Mar. 9, 2023.

(51) Int. Cl. H02M 3/335; H02M 1/00

(52) U.S. Cl. CPC H02M 3/33573; H02M 1/007; H02M 3/33571

(57) ABSTRACT

A power converter is provided that includes a power inverter, a rectifier circuit and an isolation transformer circuit. The power inverter is to convert a direct current (DC) input to an alternating current (AC) output, the power inverter including N bridge circuits connected in parallel, where N>1. The rectifier circuit is to convert the AC output to a DC output, the rectifier circuit including N+1 series diode pairs connected in parallel. The isolation transformer circuit is coupled to and between the power inverter and the rectifier circuit to transfer the AC output from the power inverter to the rectifier circuit, the isolation transformer circuit including N transformers. Respective ones of the N transformers are coupled to one of the N bridge circuits and two of the N+1 series diode pairs.

### CROSS-REFERENCE TO RELATED APPLICATION(S)

The present application claims priority to U.S. Provisional Patent Application No. 63/451,132, entitled: Polymorphic Multi-Mode DC-DC Converter, filed on Mar. 9, 2023, the content of which is hereby incorporated by reference in its entirety.

### TECHNOLOGICAL FIELD

The present disclosure relates generally to power converters and, in particular, to DC-DC converters.

### BACKGROUND

High-power charging systems are used in a number of applications from energy storage to electric vehicle (EV) charging. Energy storage systems (ESSs) are designed to store energy from renewable sources such as solar and wind for later use, such as to provide electricity to homes and businesses. Systems for EV charging are designed to charge the batteries of EVs quickly and efficiently. These systems may be used in both residential and commercial settings, and the charging process is often determined by a battery management system.

Many high-power charging systems are two-stage systems with a non-isolated AC-DC converter and an isolated DC-DC converter to convert an alternating current (AC) from the power grid into direct current (DC) that is compatible with the battery where the energy is stored. Two types of DC-DC converters that are used in a number of high-power charging systems are LLC (inductor-inductor-capacitor) converters and phase-shift full-bridge (PSFB) converters. In various applications, both types of converters implement soft-switching, and in particular zero voltage switching (ZVS), to reduce switching losses and improve the efficiency of the converter.

An LLC converter is generally able to achieve full-range ZVS and overall high efficiency. However, to get the output range (highest:lowest output voltage) higher than 4:1, the LLC converter requires a wide operating frequency range (3:1) and a low magnetizing inductance (Lₘ) to resonant inductance (Lᵣ) ratio (Lₘ/Lᵣ) (0.66), which results in much larger circulating current and lower overall efficiency. An LLC converter with multiple resonant tanks and operation modes may extend the gain range. But the utilization of magnetic cores is poor because the volt-second changes a lot in different modes. In addition, the large AC resonant inductor in the LLC converter may suffer high core loss because of the high flux density fluctuation and high copper loss owing to proximity and skin effects.

The PSFB converter has good controllability and a flexible voltage gain. It also takes advantage of an output inductor with low flux density fluctuation and low current ripple to avoid the severe magnetic losses from which an AC inductor suffers. However, the PSFB converter loses ZVS in a light load condition for its lagging leg because the PSFB converter relies heavily on the stored energy in a series inductor, which is limited considering the trade-off with duty cycle loss. The PSFB does not utilize the magnetizing current to help ZVS because the magnetizing inductor is shorted during transition. In addition, the magnetizing current amplitude reduces proportionally when the phase-shift increases. PSFB also suffers high circulating current at low output voltage.

Various improved isolated DC-DC converters have been proposed to extend the soft-switching range of the input voltage, output voltage and load current over which ZVS is maintained. The DC-DC converters also propose to reduce circulating current. These DC-DC converters, however, suffer from various drawbacks. It would therefore be desirable to have a system and method that takes into account at least some of the issues discussed above, as well as other possible issues.

### BRIEF SUMMARY

Example implementations of the present disclosure are directed to power converters and, in particular, to DC-DC converters. According to some example implementations, the DC-DC converter may include a primary side with a power inverter that includes N>1 bridge circuits arranged in N>1 primary cells connected in parallel, and a secondary side with a rectifier circuit that includes N+1 diode pairs arranged in N+1 secondary cells. The DC-DC converter may include an isolation transformer circuit with N>1 transformers, respective transformers of the transformer circuit coupled to one of the N>1 primary cells and two of the N+1 secondary cells.

The DC-DC converter of example implementations may combine advantages of the full-range ZVS of the LLC converter and the wide output range of PSFB. Similar to an LLC converter, the DC-DC converter may include a magnetizing inductor that enables full-range ZVS. More specifically, magnetizing current amplitudes for the N>1 bridge circuits may be independent of load current/voltage, switching frequency, and phase variations. In addition, Lₘ/Lᵣ ratios may be improved relative to other converter designs. The N>1 bridge circuits may be full bridge (H-bridge) circuits, half-bridge (half-H bridge) circuits, or full bridge circuits operable in either a full-bride mode or half-bridge mode, to extend the output range to 4:1. The DC-DC converter may also feature low circulating energy, low duty cycle loss, and reduced output DC inductor compared to the PSFB.

The present disclosure thus includes, without limitation, the following example implementations.

Some example implementations provide a power converter comprising: a power inverter to convert a direct current (DC) input to an alternating current (AC) output, the power inverter including N bridge circuits connected in parallel, where N>1; a rectifier circuit to convert the AC output to a DC output, the rectifier circuit including N+1 series diode pairs connected in parallel; and an isolation transformer circuit coupled to and between the power inverter and the rectifier circuit to transfer the AC output from the power inverter to the rectifier circuit, the isolation transformer circuit including N transformers, respective ones of the N transformers coupled to one of the N bridge circuits and two of the N+1 series diode pairs.

Some example implementations provide a method comprising: applying a direct current (DC) input to a power converter comprising a power inverter including N bridge circuits connected in parallel, where N>1, a rectifier circuit including N+1 series diode pairs connected in parallel, and an isolation transformer circuit including N transformers, respective ones of the N transformers coupled to one of the N bridge circuits and two of the N+1 series diode pairs; converting the DC input to an alternating current (AC) output by the power inverter; transferring the AC output from the power inverter to the rectifier circuit by the isolation transformer circuit; and converting the AC output to a DC output by the rectifier circuit.

These and other features, aspects, and advantages of the present disclosure will be apparent from a reading of the following detailed description together with the accompanying figures, which are briefly described below. The present disclosure includes any combination of two, three, four or more features or elements set forth in this disclosure, regardless of whether such features or elements are expressly combined or otherwise recited in a specific example implementation described herein. This disclosure is intended to be read holistically such that any separable features or elements of the disclosure, in any of its aspects and example implementations, should be viewed as combinable unless the context of the disclosure clearly dictates otherwise.

It will therefore be appreciated that this Brief Summary is provided merely for purposes of summarizing some example implementations so as to provide a basic understanding of some aspects of the disclosure. Accordingly, it will be appreciated that the above described example implementations are merely examples and should not be construed to narrow the scope or spirit of the disclosure in any way. Other example implementations, aspects and advantages will become apparent from the following detailed description taken in conjunction with the accompanying figures which illustrate, by way of example, the principles of some described example implementations.

### BRIEF DESCRIPTION OF THE FIGURE(S)

Having thus described example implementations of the disclosure in general terms, reference will now be made to the accompanying figures, which are not necessarily drawn to scale, and wherein:

FIG. 1 illustrates a power converter, implemented as a DC-DC converter, according to some example implementations of the present disclosure;

FIG. 2 illustrates the DC-DC converter implemented using full-bridge circuits, according to some example implementations of the present disclosure;

FIG. 3 illustrates the DC-DC converter implemented using half-bridge circuits, according to some example implementations;

FIG. 4 is a block diagram of control circuitry for the DC-DC converter, according to some example implementations;

FIG. 5 illustrates a DC-DC converter with two (N=2) primary cells and three secondary cells, implemented using full-bridge circuits, according to some example implementations;

FIG. 6 illustrates modulation in the time domain for the DC-DC converter of FIG. 5, according to some example implementations;

FIG. 7 illustrates a modulation function for the DC-DC converter of FIG. 5, according to some example implementations;

FIG. 8 is a state transition diagram for modulation of the DC-DC converter of FIG. 5, according to some example implementations;

FIGS. 9A, 9B and 9C illustrate zero-voltage-switching (ZVS) transitions during dead-time, in respectively the lagging leg of a conventional PSFB converter, a leading full-bridge circuit, a lagging full-bridge circuit of the DC-DC converter of FIG. 6, according to some example implementations;

FIG. 10 illustrates mode analysis of ZVS in the leading full-bridge circuit of the DC-DC converter of FIG. 5, according to some example implementations;

FIG. 11 illustrates mode analysis of ZVS in the lagging full-bridge circuit of the DC-DC converter of FIG. 5, according to some example implementations; and

FIGS. 12A, 12B, 12C and 12D are flowcharts illustrating various steps in a method according to various example implementations.

### DETAILED DESCRIPTION

Some implementations of the present disclosure will now be described more fully hereinafter with reference to the accompanying figures, in which some, but not all implementations of the disclosure are shown. Indeed, various implementations of the disclosure may be embodied in many different forms and should not be construed as limited to the implementations set forth herein; rather, these example implementations are provided so that this disclosure will be thorough and complete, and will fully convey the scope of the disclosure to those skilled in the art. Like reference numerals refer to like elements throughout.

Unless specified otherwise or clear from context, references to first, second or the like should not be construed to imply a particular order. A feature described as being above another feature (unless specified otherwise or clear from context) may instead be below, and vice versa; and similarly, features described as being to the left of another feature else may instead be to the right, and vice versa. Also, while reference may be made herein to quantitative measures, values, geometric relationships or the like, unless otherwise stated, any one or more if not all of these may be approximate to account for acceptable variations that may occur, such as those due to engineering tolerances or the like.

As used herein, unless specified otherwise or clear from context, the “or” of a set of operands is the “inclusive or” and thereby true if and only if one or more of the operands is true, as opposed to the “exclusive or” which is false when all of the operands are true. Thus, for example, “[A] or [B]” is true if [A] is true, or if [B] is true, or if both [A] and [B] are true. Further, the articles “a” and “an” mean “one or more,” unless specified otherwise or clear from context to be directed to a singular form. Furthermore, it should be understood that unless otherwise specified, the terms “data,” “content,” “digital content,” “information,” and similar terms may be at times used interchangeably.

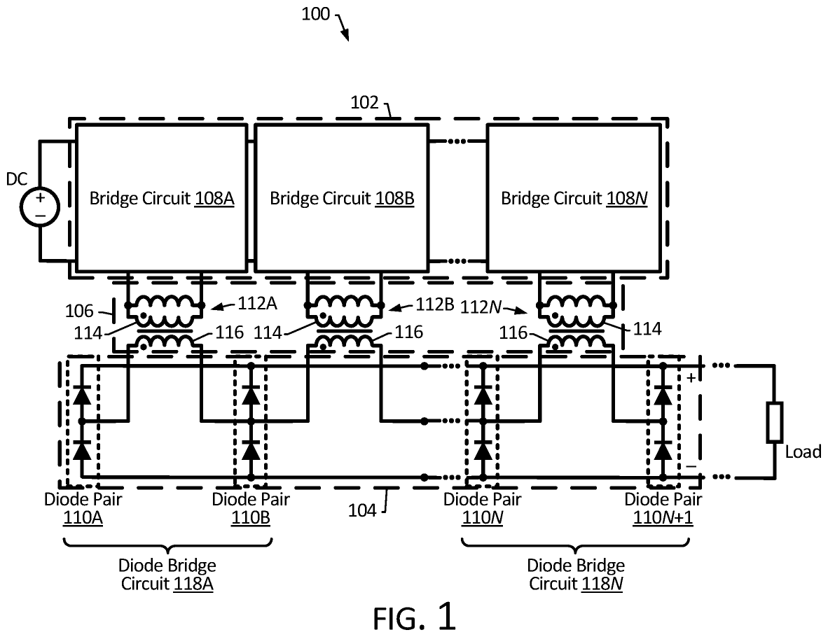

Example implementations of the present disclosure relate generally to power converters and, in particular, to DC-DC converters. FIG. 1 illustrates a power converter, implemented as a DC-DC converter 100, according to some example implementations of the present disclosure. As shown, the DC-DC converter includes a primary side with a power inverter 102, a secondary side with a rectifier circuit 104, and an isolation transformer circuit 106 coupled to and between the power inverter 102 and the rectifier circuit 104. The power inverter 102 converts a direct current (DC) input to an alternating current (AC) output. The power inverter includes N bridge circuits 108A, 108B, 108N connected in parallel (and may be arranged in N primary cells), where N>1.

The rectifier circuit 104 converts the AC output from the N bridge circuits 108A, 108B, 108N to a DC output. The rectifier circuit 104 includes N+1 series diode pairs 110A, 110B, 110N, 110N+1 connected in parallel (and may be arranged in N+1 secondary cells).

The isolation transformer circuit 106 transfers the AC output from the power inverter 102 to the rectifier circuit 104. The isolation transformer circuit includes N transformers 112A, 112B, 112N, and respective ones of the N transformers 112A, 112B, 112N include a primary winding 114 and a secondary winding 116. As shown, respective ones of the N transformers 112A, 112B, 112N are coupled to one of the N bridge circuits and two of the N+1 series diode pairs.

In some examples, the N+1 series diode pairs 110A, 110B, 110N, 110N+1 are arranged in N diode bridge circuits 118A, 118N. In some of these examples, respective ones of the N diode bridge circuits include two series diode pairs that are bridged by a secondary winding 116 of a respective one of the N transformers 112A, 112B, 112N. As shown, for example, diode bridge circuit 118A includes series diode pairs 110A, 110B that are bridged by the secondary winding 116 of transformer 112A; and diode bridge circuit 118N includes series diode pairs 110N, 110N+1 that are bridged by the secondary winding 116 of transformer 112N. In some examples, respective ones of N−1 of the N+1 series diode pairs are common to two of the N diode bridge circuits 118.

In some examples, for any n=1, 2, . . . N, the N bridge circuits 108A, 108B, 108N include a bridge circuit n, the N+1 series diode pairs 110A, 110B, 110N, 110N+1 include series diode pairs n and n+1, and the N transformers 112A, 112B, 112N include a transformer n coupled to and between the bridge circuit n and the series diode pairs n and n+1. More particularly, transformer n includes a primary winding coupled to the bridge circuit n, and a secondary winding coupled to the diode pairs n and n+1. As described, in some examples, the voltages may be normalized to per-unit values. As explained in greater detail below, the bases for the primary side and secondary side may be represented as E and E/ₙₜᵤᵣₙₛ, where E is the input voltage to the primary side and nturns is the turns ratio of the primary winding 114 to secondary winding 116 of respective ones of the N transformers.

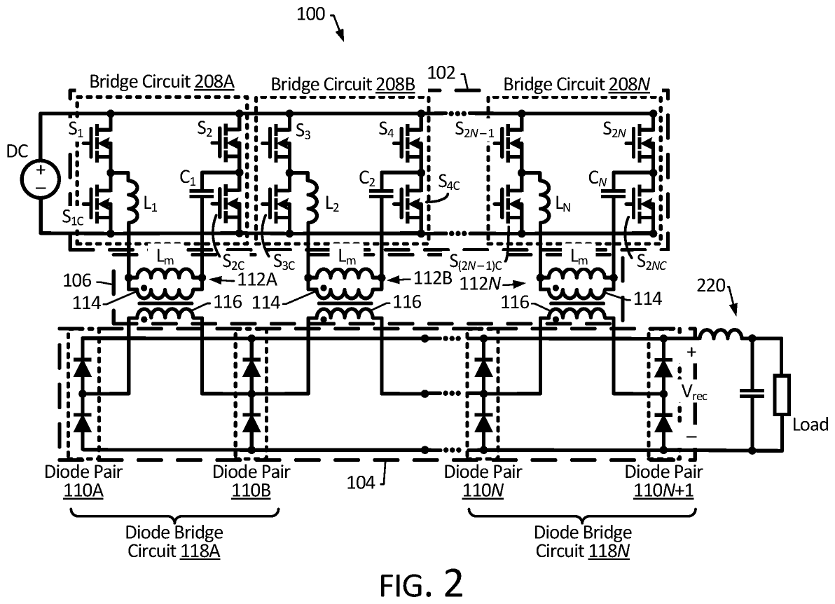

FIG. 2 illustrates the DC-DC converter 100 in which the N bridge circuits 108A, 108B, 108N are N full-bridge circuits 208A, 208B, 208N, and respective ones of the N full-bridge circuits include two switch pairs that are bridged by a primary winding 114 of a respective one of the N transformers 112A, 112B, 112N. The two switch pairs may be arranged in two legs; and the switches in the same leg of a full-bridge bridge circuit may be complementary and denoted, respectively, as Sₙ and S_{nc} (n=1, 2, 3, 4 . . . , 2N). The switch states of S₁ to S_{2N} are 2N independent control variables.

As shown, for example, full-bridge circuit 208A includes switch pairs S₁, S_{1C} and S₂, S_{2c}; full-bridge circuit 208B includes switch pairs S₃, S_{3c} and S₄, S_{4c}; and full-bridge circuit 208N includes switch pairs S_{2N-1}, S_{(2N-1)C} and S_{2N}, S_{2NC}. As also shown, in some examples, the respective ones of the N full-bridge circuits include a DC blocking capacitor C₁, C₂, C_{N}, and the respective ones of the N full-bridge circuits are selectively operable in a full-bridge mode or a half-bridge mode. As also shown, the respective ones of the N full-bridge circuits include an inductor L₁, L₂, L_{N}.

In FIG. 2, the DC output or rectifier circuit 104 is shown as a rectification voltage V_{rec}. In some examples, the DC-DC converter includes a filter circuit 220 coupled to the rectifier circuit 104, to filter the DC output of the rectifier circuit 104. As shown, the filter circuit 220 may be an inductor-capacitor (LC) circuit (at times referred to as an LC filter).

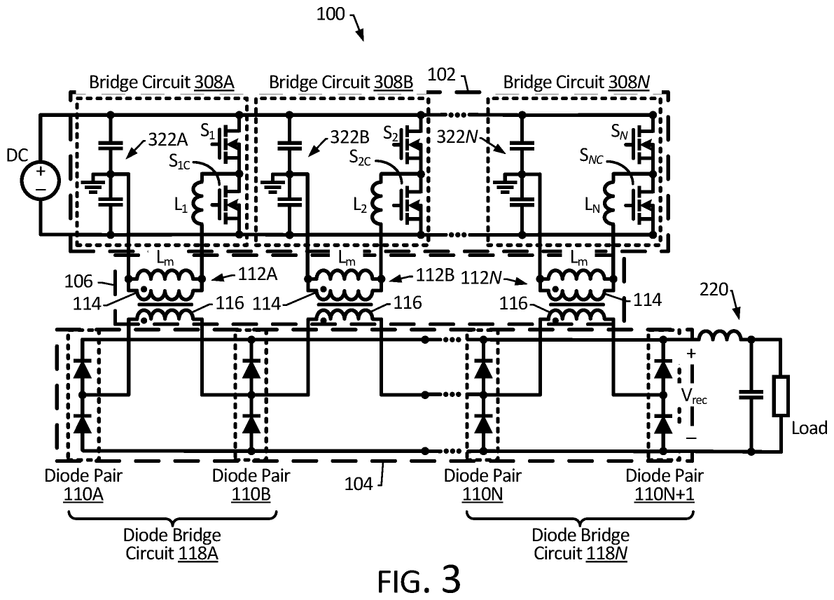

FIG. 3 illustrates the DC-DC converter 100 in which the N bridge circuits 108A, 108B, 108N are N half-bridge circuits 308A, 308B, 308N, and respective ones of the N half-bridge circuits include a switch pair bridged to a voltage supply by a respective one of N inductors L₁, L₂, L_{N} and the primary winding 114 of a respective one of the N transformers 112A, 112B, 112N. As shown, for example, half-bridge circuit 308A includes switch pair S₁, S_{1C} bridged to a capacitively-coupled voltage supply 322A by inductor L₁ and the primary winding of transformer 112A. Half-bridge circuit 308B includes switch pair S₂, S_{2C} bridged to a capacitively-coupled voltage supply 322B by inductor L₂ and the primary winding 314 of transformer 112B; and half-bridge circuit 308N includes switch pair S_{N}, S_{NC} bridged to a capacitively-coupled voltage supply 322N by inductor L_{N} and the primary winding of transformer 112N.

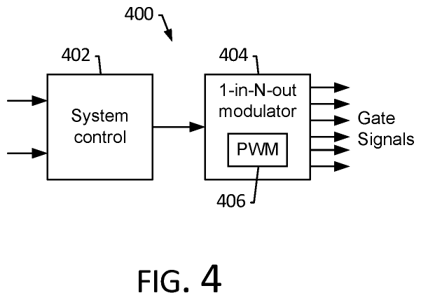

As shown in FIG. 4, in some examples, the DC-DC converter 100 includes control circuitry 400 to control switching of the switch pair(s) to cause the power inverter 102 to convert the DC input to the AC output. In particular, for example, the control circuitry may control switching of the switch pairs (S₁, S_{1C}), (S₂, S_{2C}), (S₃, S_{3C}), (S₄, S_{4C}), (S_{2N-1}, S_{(2N-1)C}) and (S_{2N}, S_{2NC}) of respective ones of the N full-bridge circuits 208A, 208B, 208N, or the switch pairs (S₁, S_{1C}), (S₂, S_{2c}) and (S_{N}, S_{NC}) of respective ones of the N half-bridge circuits 308A, 308B, 308N.

The control circuitry 400 may be implemented in a number of different manners. As shown, in some examples, the control circuitry is modular and includes a system control 402 and a modulator 404 (shown as a 1-in-N-out modulator). The system control may determine a modulation index Vₘ for a desired output voltage Vₒ or output current Iₒ from the DC-DC converter. In some examples, the modulation index is also referred to as a duty cycle. The modulator 404 may map the modulation index to gate signals, which may be output to control the switch pair(s) (S₁, S_{1C}), (S₂, S_{2C}), (S₃, S_{3C}), (S₄, S_{4C}), (S_{2N-1}, S_{(2N-1)C}) and (S_{2N}, S_{2NC}) of the N full-bridge circuits 208A, 208B, 208N, or the switch pair(s) (S₁, S_{1C}), (S₂, S_{2C}) and (S_{N}, S_{NC}) of the N half-bridge circuits 308A, 308B, 308N. In some examples, the control circuitry 400 may implement a dual-loop control method for output voltage and current at the system level in which the DC-DC converter is treated as a whole, regardless of the number N of the primary cells.

In some examples, the control circuitry 400 includes pulse-width modulation (PWM) control circuitry 406 to generate PWM signals to drive the switch pair(s) the switch pair(s) (S₁, S_{1C}), (S₂, S_{2C}), (S₃, S_{3C}), (S₄, S_{4C}), (S_{2N-1}, S_{(2N-1)C}) and (S_{2N}, S_{2NC}) of the N full-bridge circuits 208A, 208B, 208N, or the switch pair(s) (S₁, S_{1C}), (S₂, S_{2C}) and (S_{N}, S_{NC}) of the N half-bridge circuits 308A, 308B, 308N. In some of these examples, the control circuitry 400 may adjust the PWM signals provided by PWM control circuitry 406 to achieve zero-voltage switching of the switch pair(s) of the respective ones of the N bridge circuits.

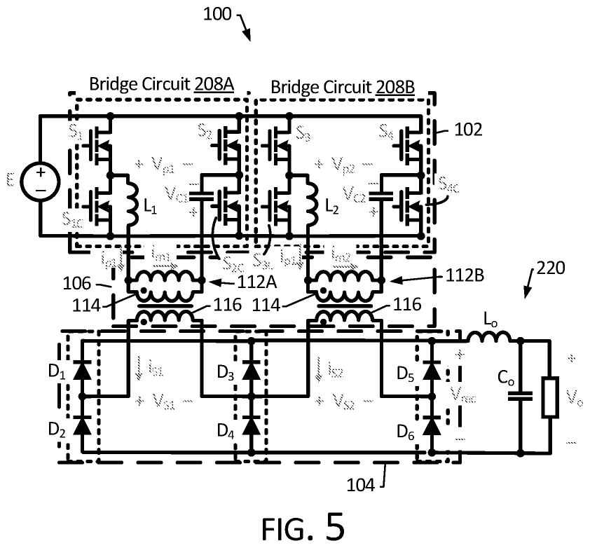

To explain the operating principle of the DC-DC converter 100 for the case N=2, and in which the DC-DC converter 100 is implemented using N full-bridge circuits 208A, 208B, reference is made to FIGS. 5-11. It should be understood, however, that the operating principle may be equally applicable for cases in which N>2. Likewise, it should be understood that the operating principle may be equally applicable for cases in which the bridge circuits are N half-bridge circuits 308A, 308B, 308N.

FIG. 5 illustrates the DC-DC converter 100 with two (N=2) primary cells and three secondary cells, implemented using full-bridge circuits 208A, 208B, according to some example implementations. The full-bridge circuit 208A (n=1) may be referred to as the leading full-bridge circuit (leading H-bridge), and the other full-bridge circuit 208B (n=2) may be referred to as the lagging full-bridge circuit (lagging H-bridge). As indicated above, the switches in the same leg of a bridge circuit are complementary and defined as Sₙ and S_{nc} (n=1, 2, 3, 4). The switch states of S₁ to S₄ are 4 independent control variables. As described, depending on context, S₁ to S₄ (or more generally Sₙ and S_{nc}) may refer to switches or their switch states. The switch states of S₁ to S₄ are defined in (1).

$${S}_{n ( c )} = \{ \begin{matrix}1 , {S}_{n ( c )} is on \\ 0 , {S}_{n ( c )} is off\end{matrix} ( n = 1 , 2 , 3 , 4 ) \qquad ( 1 )$$

To make the magnetizing current amplitude independent of working conditions and extend the output voltage range, both of the two full-bridge circuits 208A, 208B may work in full-bridge mode or half-bridge mode. In the full-bridge mode, S₁(S₃) and S₂(S₄) may be totally out of phase and the per unit (“p.u.”) voltage of DC blocking capacitor Cₙ, V_{Cn(p.u.)} is 0. In the half-bridge mode, S₁ (S₃) switches with 50% duty cycle and S₂(S₄) is always 0 (or 1). The corresponding V_{Cn(p.u.)} may be 0.5 (or −0.5). Since V_{Cn(p.u.)}=0.5 and V_{Cn(p.u.)}=−0.5 may be equivalent from an output voltage point of view, without loss of generality, only considering V_{C(p.u.)}=0.5 in FIG. 5, as shown in (2).

$${V}_{Cn ( p . u . )} = \{ \begin{matrix}0.5 , half ‐ bridge mode \\ 0 , full ‐ bridge mode\end{matrix} ( n = 1 , 2 ) \qquad ( 2 )$$

The voltages across series inductors L₁ and L₂ may be neglected for simplicity. Based on the Kirchhoff's Voltage Law, the per unit output voltages V_{S1} and V_{S2} of the two full-bridge circuits 208A, 208B may be derived:

$$\{ \begin{matrix}{V}_{S 1 ( p . u . )} = {S}_{1} - {S}_{2} - {V}_{C 1 ( p . u . )} \\ {V}_{S 2 ( p . u . )} = {S}_{3} - {S}_{4} - {V}_{C 2 ( p . u . )}\end{matrix} \qquad ( 3 )$$

In (3), S₁, S₂, S₃ and S₄ refer to switch state (0, 1) of the respective switches.

The outputs of the two full-bridge circuits 208A, 208B may be connected by a rectifier circuit 104, shown in FIG. 5 as an asymmetric three-phase diode rectifier circuit (N+1=3) through an isolation transformer circuit 106. According to the features of three-phase diode rectifier circuit, the relationship between inputs V_{S1} and V_{S2} and rectified output V_{rec} may be described in (4).

$${V}_{rec} = max \{ \vert {V}_{S 1} \vert , \vert {V}_{S 2} \vert , \vert {V}_{S 1} + {V}_{S 2} \vert \} \qquad ( 4 )$$

For the leading full-bridge circuit 208A, all six possible combinations of input variables S₁, S₂, V_{C1} and corresponding output V_{S1} are listed in left side of Table I after removing the symmetric V_{C(p.u.)}=−0.5 cases. Similarly, the right side of Table I shows the six cases for the lagging full-bridge circuit.

TABLE I
Switching states for full-bridge circuit with DC blocking cap

| Inputs | | | Output | Inputs | | | Output |
|---|---|---|---|---|---|---|---|
| S₁ | S₂ | V_{C1} | V_{S1} | S₃ | S₄ | V_{C2} | V_{S2} |
| 0 | 0 | 0 | 0 | 0 | 0 | 0 | 0 |
| 0 | 1 | 0 | −1 | 0 | 1 | 0 | −1 |
| 1 | 0 | 0 | 1 | 1 | 0 | 0 | 1 |
| 1 | 1 | 0 | 0 | 1 | 1 | 0 | 0 |
| 0 | 0 | 0.5 | −0.5 | 0 | 0 | 0.5 | −0.5 |
| 1 | 0 | 0.5 | 0.5 | 1 | 0 | 0.5 | 0.5 |

As shown in Table I, both of the leading and lagging full-bridge circuit inputs include six cases. Therefore, there may be 6×6=36 input combinations in total, as shown in Table II.

To make the magnetizing currents iₘ₁, iₘ₂ of the primary windings 114 of the respective transformers 112, independent of load current, voltage, and phase variations to achieve full-range ZVS, there may be no phase-shift within the leading and lagging full-bridge circuits 208A, 208B. The controllability of the output voltage (or output current) may come from the phase-shift between the two respective full-bridge circuits 208A, 208B. Therefore, switching states with zero output voltage may be eliminated. And to make the two full-bridge circuits 208A, 208B work at the same switching frequency and have the same magnetizing current amplitude, the switching states with different |V_{S1}| and |V_{S2}| may be removed.

TABLE II
Switching states and associated outputs
for DC-DC converter of FIG. 5

| | Input Variables | | | | | | Intermediate | | Output |
|---|---|---|---|---|---|---|---|---|---|
| State | S₁ | S₂ | V_{C1} | S₃ | S₄ | V_{C2} | V_{S1} | V_{S2} | V_{rec} |
| 1 | 1 | 0 | 0 | 1 | 0 | 0 | 1 | 1 | 2 |
| 2 | 0 | 1 | 0 | 0 | 1 | 0 | −1 | −1 | 2 |
| 3 | 1 | 0 | 0 | 1 | 0 | 0.5 | 1 | 0.5 | 1.5 |
| 4 | 0 | 1 | 0 | 0 | 0 | 0.5 | −1 | −0.5 | 1.5 |
| 5 | 1 | 0 | 0.5 | 1 | 0 | 0 | 0.5 | 1 | 1.5 |
| 6 | 0 | 0 | 0.5 | 0 | 1 | 0 | −0.5 | −1 | 1.5 |
| 7 | 1 | 0 | 0 | 0 | 1 | 0 | 1 | −1 | 1 |
| 8 | 0 | 1 | 0 | 1 | 0 | 0 | −1 | 1 | 1 |
| 9 | 1 | 0 | 0 | 0 | 0 | 0.5 | 1 | −0.5 | 1 |
| 10 | 0 | 1 | 0 | 1 | 0 | 0.5 | −1 | 0.5 | 1 |
| 11 | 1 | 0 | 0 | 0 | 0 | 0 | 1 | 0 | 1 |
| 12 | 1 | 0 | 0 | 1 | 1 | 0 | 1 | 0 | 1 |
| 13 | 0 | 1 | 0 | 0 | 0 | 0 | −1 | 0 | 1 |
| 14 | 0 | 1 | 0 | 1 | 1 | 0 | −1 | 0 | 1 |
| 15 | 1 | 0 | 0.5 | 0 | 1 | 0 | 0.5 | −1 | 1 |
| 16 | 0 | 0 | 0.5 | 1 | 0 | 0 | −0.5 | 1 | 1 |
| 17 | 1 | 0 | 0.5 | 1 | 0 | 0.5 | 0.5 | 0.5 | 1 |
| 18 | 0 | 0 | 0.5 | 0 | 0 | 0.5 | −0.5 | −0.5 | 1 |
| 19 | 0 | 0 | 0 | 1 | 0 | 0 | 0 | 1 | 1 |
| 20 | 1 | 1 | 0 | 1 | 0 | 0 | 0 | 1 | 1 |
| 21 | 0 | 0 | 0 | 0 | 1 | 0 | 0 | −1 | 1 |
| 22 | 1 | 1 | 0 | 0 | 1 | 0 | 0 | −1 | 1 |
| 23 | 1 | 0 | 0.5 | 0 | 0 | 0.5 | 0.5 | −0.5 | 0.5 |
| 24 | 0 | 0 | 0.5 | 1 | 0 | 0.5 | −0.5 | 0.5 | 0.5 |
| 25 | 1 | 0 | 0.5 | 0 | 0 | 0 | 0.5 | 0 | 0.5 |
| 26 | 1 | 0 | 0.5 | 1 | 1 | 0 | 0.5 | 0 | 0.5 |
| 27 | 0 | 0 | 0.5 | 0 | 0 | 0 | −0.5 | 0 | 0.5 |
| 28 | 0 | 0 | 0.5 | 1 | 1 | 0 | −0.5 | 0 | 0.5 |
| 29 | 0 | 0 | 0 | 1 | 0 | 0.5 | 0 | 0.5 | 0.5 |
| 30 | 1 | 1 | 0 | 1 | 0 | 0.5 | 0 | 0.5 | 0.5 |
| 31 | 0 | 0 | 0 | 0 | 0 | 0.5 | 0 | −0.5 | 0.5 |
| 32 | 1 | 1 | 0 | 0 | 0 | 0.5 | 0 | −0.5 | 0.5 |
| 33 | 0 | 0 | 0 | 0 | 0 | 0 | 0 | 0 | 0 |
| 34 | 0 | 0 | 0 | 1 | 1 | 0 | 0 | 0 | 0 |
| 35 | 1 | 1 | 0 | 0 | 0 | 0 | 0 | 0 | 0 |
| 36 | 1 | 1 | 0 | 1 | 1 | 0 | 0 | 0 | 0 |

After eliminating the switching states with zero output voltage, and removing the switching states with different |V_{S1}| and |V_{S2}|, the remaining 8 switching states 1, 2, 7, 8, 17, 18, 23 and 24 may be selected to enable ZVS by magnetizing currents and implement 3-level operation.

Multi-level modulation method for the DC-DC converter. For a voltage-source converter with isolation transformer, the modulation scheme of some example implementations may combine the switching states to get the desired output voltage and keep the volt-second balance of the isolation transformer circuit 106. The modulation method may focus on the relationship between modulation index Vₘ and output voltage Vₒ while the dead-time may be neglected at this stage. The output voltage of the circuit may be equal to the average of rectification voltage V_{rec}, as shown in (5).

$${V}_{o} = {\overline{V}}_{rec} \qquad ( 5 )$$

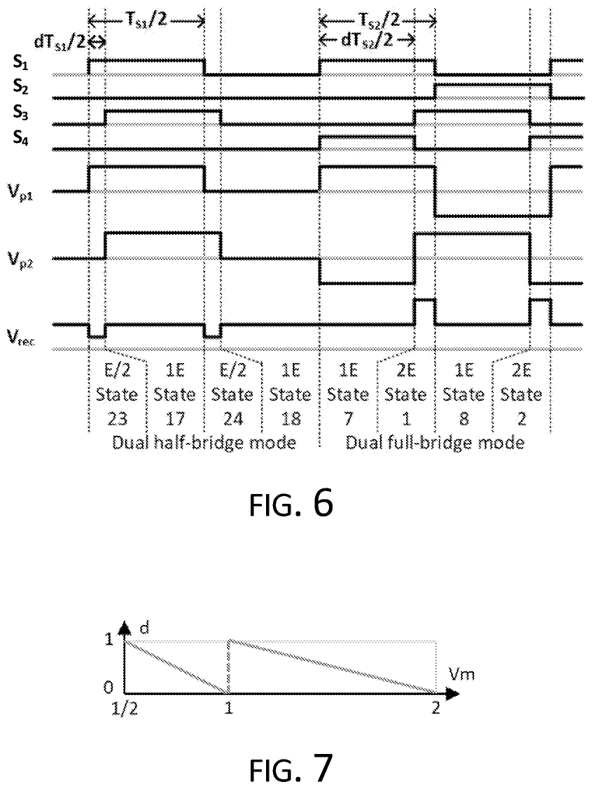

If the output voltage Vₒ is between 0.5 to 1 in per unit system (Vₒ normalized to E/nₜᵤᵣₙₛ as explained above), states 17, 18, 23, 24 may be selected and combined in the way shown in the left part of FIG. 6. Since both of the two full-bridge circuits 208A, 208B work as half-bridges, this mode may be defined as dual half-bridge mode. The switching period may be T_{S1} and the duty cycle d may be defined as the ratio of the time duration of state 23 (or 24) and half of switching period T_{S1}/2. The output voltage in this case may be calculated in (6).

$${\overline{V}}_{rec ( p . u . )} = ( 1 - d ) \cdot 1 + d \cdot \frac{1}{2} = \frac{1}{2} ( 2 - d ) \qquad ( 6 )$$

The magnetizing current peak in this case may be as shown in (7).

$${I}_{{m}_{pk 1}} = \frac{1}{2} \cdot \frac{E}{2} \cdot \frac{{T}_{S 1}}{2} \cdot \frac{1}{{L}_{m}} = \frac{E \cdot {T}_{S 1}}{8 {L}_{m}} \qquad ( 7 )$$

Similarly, if the output voltage is between 1 to 2 in per unit system, state 1, 2, 7, 8 may be selected and combined in the way shown in the right part of FIG. 6. This mode may be defined as dual full-bridge mode. The switching period may be T_{S2} and the duty cycle d may be defined as the ratio of time duration for state 7 (or 8) and half of switching period T_{S2}/2. The output voltage in this case may be as calculated in (8).

$${V}_{rec ( p . u . )} = ( 1 - d ) \cdot 2 + d = 2 - d \qquad ( 8 )$$

The magnetizing current peak in this case may be as shown in (9).

$${I}_{{m}_{pk 2}} = \frac{1}{2} \cdot E \cdot \frac{{T}_{S 2}}{2} \cdot \frac{1}{{L}_{m}} = \frac{E \cdot {T}_{S 2}}{4 {L}_{m}} \qquad ( 9 )$$

To improve utilization of the magnetic cores and improve the overall efficiency by lowering the switching frequency of the dual half-bridge mode, the volt-second of the isolation transformer circuit 106 and output inductor Lo (as shown in FIG. 5), which may be proportional to the peak of magnetizing currents, may be the same for the dual full-bridge mode and the dual half-bridge mode. Therefore, the relationship between T_{S1} and T_{S2} may be as shown in (10).

$${T}_{S 1} = 2 \cdot {T}_{S 2} {=}^{△} 2 \cdot {T}_{S} \qquad ( 10 )$$

The modulation method of some example implementations of the present disclosure is shown in (11) and FIG. 7.

$$d = \{ \begin{matrix}2 - 2 {V}_{m} , \frac{1}{2} \leq {V}_{m} < 1 \\ 2 - {V}_{m} , 1 \leq {V}_{m} \leq 2\end{matrix} \qquad ( 11 )$$

In (11), Vₘ=V_{o(p.u.)}

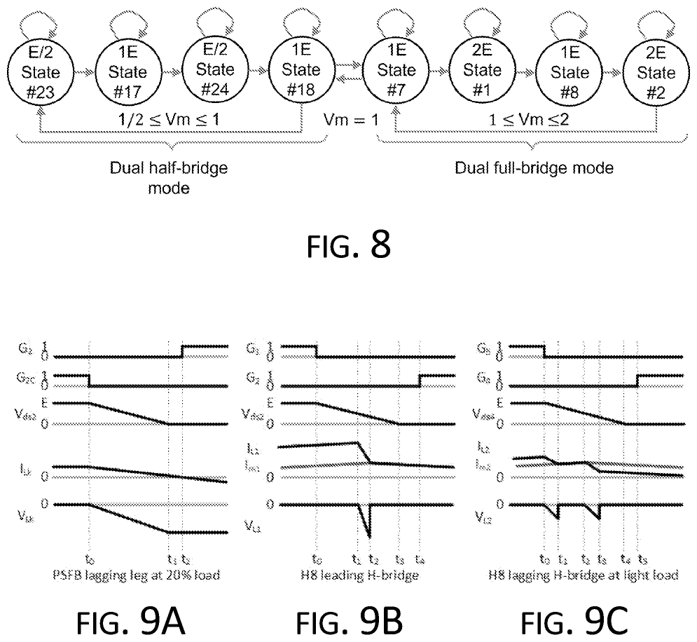

According to the time domain modulation shown in FIG. 6 and the modulation function (11), the state transition diagram shown in FIG. 8 may be obtained. Substituting (11) into (6) and (8), the relationship between modulation index Vₘ and the average of rectification voltage V_{rec(p.u.)} may be derived as:

$${\overline{V}}_{rec ( p . u . )} = {V}_{m} \qquad ( 12 )$$

In summary, the modulation index Vₘ may exhibit a linear relationship to the average of rectification voltage \hat{V}_{rec} for the whole output voltage range. The modulation scheme of some example implementations may achieve a 4:1 output voltage range and 3-level operation. In addition, the magnetizing current amplitudes of the two transformers 112A, 112B may be independent of phase variations, load current and voltage. The next subsection moves on to discuss how the magnetizing currents enable full-range ZVS for all active switches.

ZVS operational principles in leading and lagging full-bridge circuits. For a PSFB circuit, during ZVS transitions, its rectification voltage V_{rec} may be shorted, and a series inductance Lₖ may hold the whole primary side voltage, as the series inductance voltage V_{L}_{ₖ} waveform. This is shown in FIG. 9A in which G₂, G_{2C} refer to states of a switch pair S₂, S_{2C} of the lagging leg of the PSFB circuit, V_{ds2} is the drain-source voltage of S₂, and I_{L}_{ₖ} is the series inductance current. The lighter load may benefit from a much larger series inductance Lₖ to slow down the current decline and provide more energy to create ZVS condition for the lagging leg. In contrast to the PSFB circuit, the voltage drops on series inductors of the circuit may be greatly decreased, as shown in FIG. 9B for the leading full-bridge circuit 208A and FIG. 9C for the lagging full-bridge circuit 208B of the DC-DC converter 100 in FIG. 5 (referred to in FIGS. 9B and 9C as “H8”). In consequence, the two series inductors L₁, L₂ in the circuit of some example implementations may both be significantly reduced.

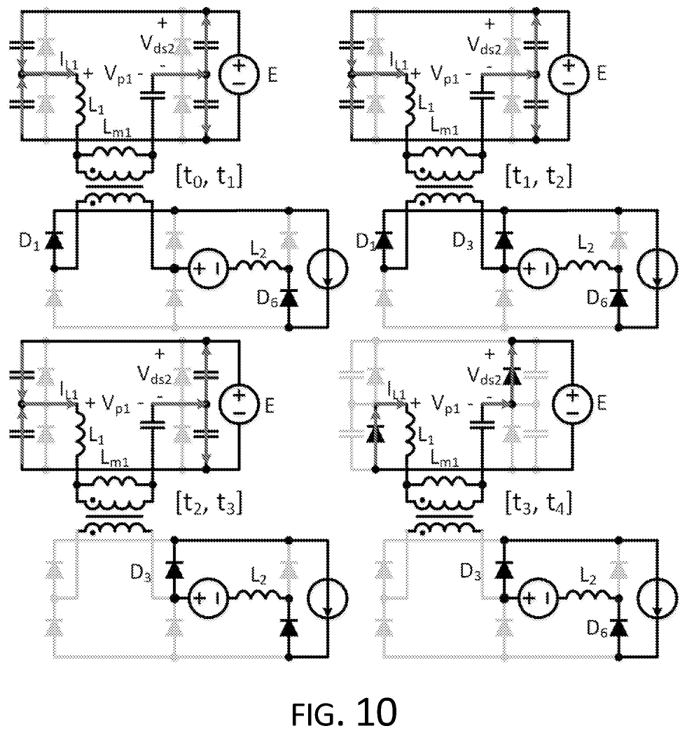

1) Full-range ZVS for the leading full-bridge circuit independent of series inductance: The leading full-bridge circuit 208A time-domain ZVS transitions and mode analysis are shown in FIG. 9B and FIG. 10, and described below with further reference to the DC-DC converter 100 in FIG. 5.

Mode [t₀, t₁]: S₁ may be turned off at t₀ but i_{L1} may be almost constant before V_{ds2} drops to E/2(V_{P1}=0 at this point). Under the assumption that n²Lₒ(output inductor Lo modeled as a current source in FIG. 10) is much larger than L₁ and L₂, the voltage drop on L₁ may be close to 0, and most of the voltage may drop on the output inductor Lₒ, as shown in (13).

$$\vert {V}_{L 1} \vert \approx \frac{{L}_{1}}{{L}_{1} + {L}_{2} + {n}^{2} {L}_{o}} ( \vert {V}_{P 1} + E - {nV}_{o} \vert ) \approx 0 \qquad ( 13 )$$

Mode [t₁, t₂]: at t₁, V_{ds2} may equal E/2 and i_{L1} may begin to drop until reaches magnetizing current iₘ₁ at t₂. The time interval of this mode may be zero if L₁=0. The leading transformer 112A secondary side 116 may be shorted by diodes D₁ and D₃ of respective diode pairs (D₁, D₂) and (D₃, D₄). The lagging full-bridge circuit may support the load current through diodes D₃ and D₆, where D₆ is of diode pair (D₅, D₆).

Mode [t₂, t₃]: the output of leading full-bridge circuit may be blocked and clamped by the lagging transformer 112B output voltage and the lagging full-bridge circuit may independently support the load current. As a result, L₁ may be in series with magnetizing inductor Lₘ₁ and the voltage drop on L₁ may go back to around 0 as shown in (14). This mode may end when V_{ds2} drops to 0

$$\vert {V}_{L 1} \vert = \frac{{L}_{1}}{{L}_{1} + {L}_{m 1}} \vert {V}_{P 1} \vert \approx 0 \qquad ( 14 )$$

Mode [t₃, t₄]: at t₃, V_{ds2} may remain at 0 and the body diodes of S₂ and S_{1C} may conduct. S₂ and S_{1C} may be turned on at t₄ and the soft-switching process for the leading full-bridge circuit may be complete. The voltage on L₁ may still be close to 0 and the voltage drop may be mainly on Lₘ₁. It's worthwhile to point out the low turn-on current (equals magnetizing current) of active switches may be true under all conditions because of the extremely low series inductance.

$$\vert {V}_{L 1} \vert \approx \frac{{L}_{1}}{{L}_{1} + {L}_{m 1}} E \approx 0 \qquad ( 15 )$$

Taken together, similar to LLC, the full-range ZVS may be enabled by the magnetizing inductor (transformer inductance) under any output voltage and load conditions for the leading full-bridge circuit. What's more, the ZVS condition may be independent of the value of L₁. In consequence, L₁ may be as small as possible to reduce the duty cycle loss and improve efficiency.

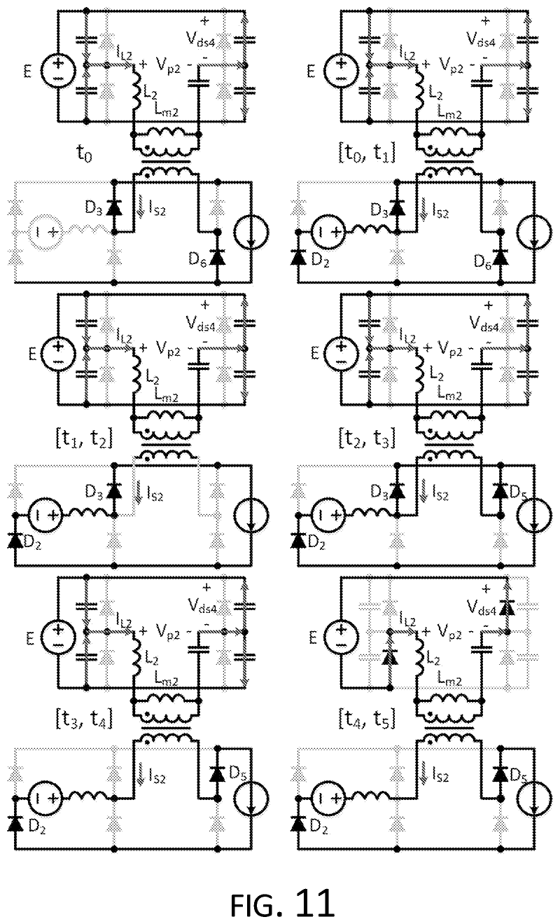

2) ZVS transitions for the lagging full-bridge circuit with 4 times series inductance reduction: Similar to the PSFB, the ZVS of the lagging full-bridge circuit 208B may not be a problem at heavy load. Therefore, the analysis focuses on the light load condition. The lagging full-bridge circuit time-domain ZVS transitions and mode analysis at light load may be as shown in FIG. 9C and FIG. 11, and described below with further reference to the DC-DC converter 100 in FIG. 5.

Mode [t₀, t₁]: S₃ and S_{4C} may be turned off at t₀. i_{L2} begins to drop and the voltage on L₂ may be as shown in (16). The two full-bridge circuits 208A, 208B may be in parallel and the load current transits from the lagging full-bridge circuit to the leading full-bridge circuit. At t₁, i_{L2} drops to magnetizing current iₘ₂ and the secondary side current may be 0.

$$\vert {V}_{L 2} \vert = \frac{{L}_{2}}{{L}_{1} + {L}_{2}} \vert {V}_{P 2} - E \vert \qquad ( 16 )$$

Mode [t₁, t₂]: the load current may be fully supported by the leading full-bridge circuit. The output of the lagging full-bridge circuit may be blocked and clamped to the output of leading full-bridge circuit. L₂ may be in series with Lₘ₂ and the voltage drop on L₂ may be close to 0 as shown in (17).

$$\vert {V}_{L 2} \vert = \frac{{L}_{2}}{{L}_{2} + {L}_{m 2}} \vert {V}_{P 2} \vert \approx 0 \qquad ( 17 )$$

This mode may end when V_{ds4} drops to E/2. At this point, i_{L2} still equals iₘ₂, which may be around its peak value during dead-time. Suppose the minimum load current of the PSFB to maintain soft-switching may be the same value as the magnetizing current amplitude in the DC-DC converter 100 in FIG. 5, and Lₖ may be the series inductance for the PSFB under this condition, the energy stored in Lₖ may discharge V_{ds2} from E to 0. In contrast, for the DC-DC converter 100, the energy stored in L₂ may discharge V_{ds4} from E/2 to 0. Because the soft-switching energy may be proportional to the square of the voltage, and the energy stored in inductor may be proportional to the inductance L₂ in the DC-DC converter 100 may be ¼ of Lₖ in the PSFB.

Mode [t₂, t₃]: V_{S2} may be shorted by D₃ and D₅ and i_{L2} may drop from magnetizing current iₘ₂. The voltage applied on L₂ may be as shown in (18). This mode may end when i_{S2} reaches load current.

$$\vert {V}_{L 2} \vert = \vert {V}_{P 2} \vert \qquad ( 18 )$$

Mode [t₃, t₄]: V_{ds4} may continue to drop and reaches 0 at t₄. Under the assumption of Lₘ and n²Lₒ may be much larger than L₁ and L₂, the voltage on L₂ may be as shown in (19).

$$\vert {V}_{L 2} \vert \approx \frac{{L}_{2}}{{L}_{1} + {L}_{2 + {n}^{2} {L}_{o}}} ( \vert {V}_{P 2} + E - {nV}_{o} \vert ) \approx 0 \qquad ( 19 )$$

Mode [t₄, t₅]: At t₄, the body diodes of S₄ and S_{3C} may conduct. S₄ and S_{3C} may be turned on at t₅ and the soft-switching process for the lagging full-bridge circuit 208B may be done. The voltage on L₁ may still be close to 0 as shown in (19).

For the lagging full-bridge circuit 208B, the DC-DC converter 100 in FIG. 5 may greatly reduce the volt-second applied on the series inductors during the ZVS transitions. Especially in mode[t₁, t₂], L₂ may be in series with Lₘ and the inductors may discharge V_{ds4} to E/2 together. The magnetizing inductor may be shorted after this mode but the current of L₂ may be no less than Iₘ_{ₚₖ₂} at the beginning even under no load condition. Additionally, L₂ may only discharge V_{ds4} from E/2 to 0. Therefore, the leakage inductance may be reduced at least 4 times.

The following are various design considerations for the DC-DC converter 100 for the case N=2, and in which the DC-DC converter 100 is implemented using full-bridge circuits 208A, 208B (H-bridges). Again, it should be understood that the design considerations may be equally applicable for cases in which N>2. The design considerations may be equally applicable for cases in which the bridge circuits are half bridge circuits (half-H bridges).

According to some example implementations, the voltage-second of the transformers 112A, 112B and output inductor Lₒ may be kept the same in the dual full-bridge mode and dual half-bridge mode by adjusting the switching frequency shown in (10). Therefore, the transformer and output inductor design for the two modes may be the same and the following discussion may be based on the dual full-bridge mode.

Magnetizing inductors design for full-range ZVS. For the leading and lagging full-bridge circuits 208A, 208B, the magnetizing inductance may be designed to achieve full-range ZVS under no-load condition. By adopting the modulation scheme of some example implementations, the magnetizing current peak may appear during the dead-time and may be independent of output voltage and phase variation. Therefore, the target for magnetizing current peak may be to finish soft-switching transition within dead-time t_{dt}, as shown in (20).

$${i}_{{m}_{pk}} \geq \frac{2 {C}_{oss} E}{{t}_{dt}} \qquad ( 20 )$$

Substituting (20) into (9), the magnetizing inductance may be as in (21).

$${L}_{m} \leq \frac{{T}_{s} {t}_{dt}}{8 {C}_{oss}} \qquad ( 21 )$$

In order to reduce the MOSFET conduction loss and turnoff loss, Lₘ, may be designed as the maximum value in (21).

Transformers turns ratio. Assume the turns ratio for the leading transformer 112A is nₜᵤᵣₙₛ₁. 1 and the lagging is nₜᵤᵣₙₛ₂: 1. From (4), the minimum output voltage for the dual full-bridge mode may be as in (22), and the maximum output voltage for the dual half-bridge mode may be as in (23). The equality happens when nₜᵤᵣₙₛ₁=nₜᵤᵣₙₛ₂. Therefore, to achieve the 4:1 output voltage range, the transformers' turns ratio may be the same and defined as nₜᵤᵣₙₛ.

$${V}_{o - min - FB} = max \{ \frac{E}{{n}_{turns 1}} , \frac{E}{{n}_{turns 2}} \} \qquad ( 22 )$$

$${V}_{o - min - HB} = \frac{E}{2 {n}_{turns 1}} + \frac{E}{2 {n}_{turns 2}} \leq max \{ \frac{E}{{n}_{turns 1}} , \frac{E}{{n}_{turns 2}} \} \qquad ( 23 )$$

The turns ratio may be determined by the maximum output voltage and minimum input voltage, as shown in (24).

$${n}_{turns} = \frac{2 {V}_{in - min}}{{V}_{o - max}} \qquad ( 24 )$$

Series inductor in leading full-bridge circuit and duty cycle loss. For the leading full-bridge circuit 208A, the series inductor L₁ may be designed as small as possible because the ZVS is independent of the value of L₁ and a lower inductance may reduce the duty cycle loss, circulating current, magnetic losses, and the stress on a snubber circuit.

The duty cycle loss at maximum load current may be determined by the output voltage transition and leakage inductance. For the leading full-bridge circuit 208A transition in the DC-DC converter 100 in FIG. 5, the output of diode bridge drop from the addition of the output of the two full-bridge circuits 208A, 208B to the lagging full-bridge circuit output rather than drop to zero. Additionally, the extremely low series inductance relative to PSFB may improve the speed of current transition. As a consequence, the duty cycle loss may be close to zero for the leading full-bridge circuit transition. In addition, the circulating current between primary and secondary side may also be close to zero.

The small leakage inductance creates a low current turn-on condition for active switches and the turn-on current may be the amplitude of the magnetizing current.

Series inductor in lagging full-bridge circuit for full-range ZVS. As stated in mode[t₁, t₂] of the lagging full-bridge circuit 208B, the series inductor L₂ may be ¼ of Lₖ in the PSFB under the same series inductor current.

The minimum current of Lₖ to achieve ZVS in the PSFB may be set by load current. But the load current decays in the free-wheeling stage because the switches and the diodes have nonzero forward voltage drops. The minimum current of L₂ in the DC-DC converter 100 in FIG. 5 may be set by the amplitude of the magnetizing current Iₘ_{ₚₖ₂}, which may be independent of load current, voltage, and phase-shift between the two full-bridge circuits 208A, 208B.

The circuit of some example implementations may therefore achieve complete ZVS even at no-load condition. The series inductance may be as calculated in (25).

$${L}_{2} = \frac{4 {C}_{oss} \cdot {( E / 2 )}^{2}}{{I}_{{m}_{pk 2}}^{2}} = \frac{{C}_{oss} {E}^{2}}{{I}_{{m}_{pk 2}}^{2}} \qquad ( 25 )$$

Output inductor design and size reduction. For the dual full-bridge mode, the peak-to-peak current ripple may be designed to be less than 20% of rated current, as shown in (26). The dual half-bridge mode follows the same rule.

$$Δ {i}_{pk - pk} = \frac{( {V}_{o} - E / n ) {dT}_{s} / 2}{{L}_{o}} \qquad ( 26 )$$

Substituting (8) into (26), to derive an expression of the output inductor Lo:

$${L}_{o} \geq \frac{d ( 1 - d ) {ET}_{s}}{2 n Δ {i}_{pk - pk}} \qquad ( 27 )$$

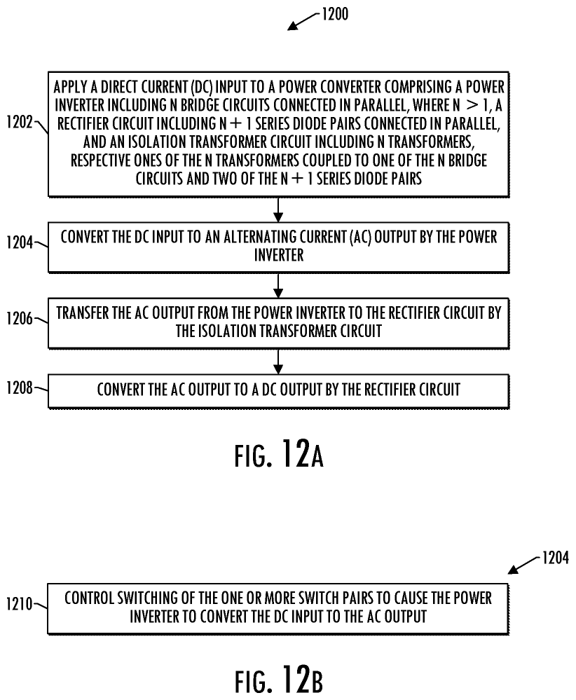

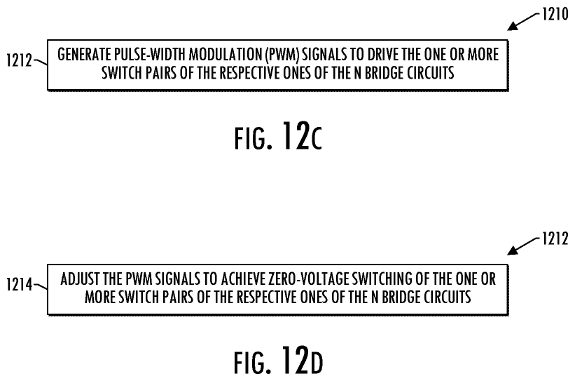

FIGS. 12A-12D are flowcharts illustrating various steps in a method 1200 according to various example implementations. As shown at block 1202 of FIG. 12A, the method includes applying a direct current (DC) input to a power converter. In this regard, the power converter comprises a power inverter including N bridge circuits connected in parallel, where N>1, a rectifier circuit including N+1 series diode pairs connected in parallel, and an isolation transformer circuit including N transformers, respective ones of the N transformers coupled to one of the N bridge circuits and two of the N+1 series diode pairs. The method includes converting the DC input to an alternating current (AC) output by the power inverter, as shown at block 1204. The method includes transferring the AC output from the power inverter to the rectifier circuit by the isolation transformer circuit, as shown at block 1206. The method includes converting the AC output to a DC output by the rectifier circuit, as shown at block 1208.

In some examples, the DC input is applied to the power converter at block 1202 in which the N bridge circuits include a bridge circuit n, the N+1 series diode pairs include series diode pairs n and n+1, and the N transformers include a transformer n coupled to and between the bridge circuit n and the series diode pairs n and n+1.

In some examples, the DC input is converted to the AC output at block 1204 by the power inverter in which the N bridge circuits are N full-bridge circuits, and respective ones of the N full-bridge circuits include two switch pairs that are bridged by a primary winding of a respective one of the N transformers.

In some examples, the DC input is converted to the AC output at block 1204 by the power inverter in which the respective ones of the N full-bridge circuits include a DC blocking capacitor, and the respective ones of the N full-bridge circuits are selectively operable in a full-bridge mode or a half-bridge mode.

In some examples, the DC input is converted to the AC output at block 1204 by the power inverter in which the N bridge circuits are N half-bridge circuits, and respective ones of the N half-bridge circuits include a switch pair bridged to a voltage supply by an inductor and a primary winding of a respective one of the N transformers.

In some examples, the AC output is converted to the DC output at block 1208 by the rectifier circuit in which the N+1 series diode pairs are arranged in N diode bridge circuits, and respective ones of the N diode bridge circuits include two series diode pairs that are bridged by a secondary winding of a respective one of the N transformers.

In some examples, the AC output is converted to the DC output at block 1208 by the rectifier circuit in which the N+1 series diode pairs are arranged in N diode bridge circuits, and respective ones of N−1 of the N+1 series diode pairs are common to two of the N diode bridge circuits.

In some examples, respective ones of the N bridge circuits include one or more switch pairs. In some of these examples, converting the DC input to the AC output at block 1204 includes controlling switching of the one or more switch pairs to cause the power inverter to convert the DC input to the AC output, as shown at block 1210 of FIG. 12B.

In some examples, controlling the switching of the one or more switch pairs at block 1210 includes generating pulse-width modulation (PWM) signals to drive the one or more switch pairs of the respective ones of the N bridge circuits, as shown at block 1212 of FIG. 12C.

In some examples, generating the PWM signals at block 1212 includes adjusting the PWM signals to achieve zero-voltage switching of the one or more switch pairs of the respective ones of the N bridge circuits, as shown at block 1214 of FIG. 12D.

As explained above and reiterated below, the present disclosure includes, without limitation, the following example implementations.

Clause 1. A power converter comprising: a power inverter to convert a direct current (DC) input to an alternating current (AC) output, the power inverter including N bridge circuits connected in parallel, where N>1; a rectifier circuit to convert the AC output to a DC output, the rectifier circuit including N+1 series diode pairs connected in parallel; and an isolation transformer circuit coupled to and between the power inverter and the rectifier circuit to transfer the AC output from the power inverter to the rectifier circuit, the isolation transformer circuit including N transformers, respective ones of the N transformers coupled to one of the N bridge circuits and two of the N+1 series diode pairs.

Clause 2. The power converter of clause 1, wherein the N bridge circuits include a bridge circuit n, the N+1 series diode pairs include series diode pairs n and n+1, and the N transformers include a transformer n coupled to and between the bridge circuit n and the series diode pairs n and n+Clause 1.

Clause 3. The power converter of clause 1 or clause 2, wherein the N bridge circuits are N full-bridge circuits, and respective ones of the N full-bridge circuits include two switch pairs that are bridged by a primary winding of a respective one of the N transformers.

Clause 4. The power converter of clause 3, wherein the respective ones of the N full-bridge circuits include a DC blocking capacitor, and the respective ones of the N full-bridge circuits are selectively operable in a full-bridge mode or a half-bridge mode.

Clause 5. The power converter of any of clauses 1 to 4, wherein the N bridge circuits are N half-bridge circuits, and respective ones of the N half-bridge circuits include a switch pair bridged to a voltage supply by an inductor and a primary winding of a respective one of the N transformers.

Clause 6. The power converter of any of clauses 1 to 5, wherein the N+1 series diode pairs are arranged in N diode bridge circuits, and respective ones of the N diode bridge circuits include two series diode pairs that are bridged by a secondary winding of a respective one of the N transformers.

Clause 7. The power converter of any of clauses 1 to 6, wherein the N+1 series diode pairs are arranged in N diode bridge circuits, and respective ones of N−1 of the N+1 series diode pairs are common to two of the N diode bridge circuits.

Clause 8. The power converter of any of clauses 1 to 7, wherein respective ones of the N bridge circuits include one or more switch pairs, and the DC-DC converter comprises control circuitry to control switching of the one or more switch pairs to cause the power inverter to convert the DC input to the AC output.

Clause 9. The power converter of clause 8, wherein the control circuitry includes pulse-width modulation (PWM) control circuitry to generate PWM signals to drive the one or more switch pairs of the respective ones of the N bridge circuits.

Clause 10. The power converter of clause 9, wherein the control circuitry is to adjust the PWM signals to achieve zero-voltage switching of the one or more switch pairs of the respective ones of the N bridge circuits.

Clause 11. A method comprising: applying a direct current (DC) input to a power converter comprising a power inverter including N bridge circuits connected in parallel, where N>1, a rectifier circuit including N+1 series diode pairs connected in parallel, and an isolation transformer circuit including N transformers, respective ones of the N transformers coupled to one of the N bridge circuits and two of the N+1 series diode pairs; converting the DC input to an alternating current (AC) output by the power inverter; transferring the AC output from the power inverter to the rectifier circuit by the isolation transformer circuit; and converting the AC output to a. DC output by the rectifier circuit.

Clause 12. The method of clause 11, wherein the DC input is applied to the power converter in which the N bridge circuits include a bridge circuit n, the N+1 series diode pairs include series diode pairs n and n+1, and the N transformers include a transformer n coupled to and between the bridge circuit n and the series diode pairs n and n+Clause 1.

Clause 13. The method of clause 11 or clause 12, wherein the DC input is converted to the AC output by the power inverter in which the N bridge circuits are N full-bridge circuits, and respective ones of the N full-bridge circuits include two switch pairs that are bridged by a primary winding of a respective one of the N transformers.

Clause 14. The method of clause 13, wherein the DC input is converted to the AC output by the power inverter in which the respective ones of the AT full-bridge circuits include a DC blocking capacitor, and the respective ones of the N full-bridge circuits are selectively operable in a full-bridge mode or a half-bridge mode.

Clause 15. The method of any of clauses 11 to 14, wherein the DC input is converted to the AC output by the power inverter in which the N bridge circuits are N half-bridge circuits, and respective ones of the N half-bridge circuits include a switch pair bridged to a voltage supply by an inductor and a primary winding of a respective one of the N transformers.

Clause 16, The method of any of clauses 11 to 15, wherein the AC output is converted to the DC output by the rectifier circuit in which the N+1 series diode pairs are arranged in N diode bridge circuits, and respective ones of the N diode bridge circuits include two series diode pairs that are bridged by a secondary winding of a respective one of the N transformers.

Clause 17. The method of any of clauses 11 to 16, wherein the AC output is converted to the DC output by the rectifier circuit in which the N+1 series diode pairs are arranged in N diode bridge circuits, and respective ones of N−1 of the N+1 series diode pairs are common to two of the N diode bridge circuits.

Clause 18. The method of any of clauses 11 to 17, wherein respective ones of the N bridge circuits include one or more switch pairs, and converting the DC input to the AC output includes controlling switching of the one or more switch pairs to cause the power inverter to convert the DC input to the AC output.

Clause 19. The method of clause 18, wherein controlling the switching of the one or more switch pairs includes generating pulse-width modulation (PWM) signals to drive the one or more switch pairs of the respective ones of the N bridge circuits.

Clause 20. The method of clause 19, wherein generating the PWM signals includes adjusting the PWM signals to achieve zero-voltage switching of the one or more switch pairs of the respective ones of the N bridge circuits.

Many modifications and other implementations of the disclosure set forth herein will come to mind to one skilled in the art to which the disclosure pertains having the benefit of the teachings presented in the foregoing description and the associated figures. Therefore, it is to be understood that the disclosure is not to be limited to the specific implementations disclosed and that modifications and other implementations are intended to be included within the scope of the appended claims. Moreover, although the foregoing description and the associated figures describe example implementations in the context of certain example combinations of elements and/or functions, it should be appreciated that different combinations of elements and/or functions may be provided by alternative implementations without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

What is claimed is:

1. A power converter comprising:
a power inverter to convert a direct current (DC) input to an alternating current (AC) output, the power inverter including N bridge circuits connected in parallel, where N>1;
a rectifier circuit to convert the AC output to a DC output, the rectifier circuit including N+1 series diode pairs connected in parallel; and
an isolation transformer circuit coupled to and between the power inverter and the rectifier circuit to transfer the AC output from the power inverter to the rectifier circuit, the isolation transformer circuit including N transformers, respective ones of the N transformers coupled to one of the N bridge circuits and two of the N+1 series diode pairs.

2. The power converter of claim 1, wherein the N bridge circuits include a bridge circuit n, the N+1 series diode pairs include series diode pairs n and n+1, and the N transformers include a transformer n coupled to and between the bridge circuit n and the series diode pairs n and n+1.

3. The power converter of claim 1, wherein the N bridge circuits are N full-bridge circuits, and respective ones of the N full-bridge circuits include two switch pairs that are bridged by a primary winding of a respective one of the N transformers.

4. The power converter of claim 3, wherein the respective ones of the N full-bridge circuits include a DC blocking capacitor, and the respective ones of the N full-bridge circuits are selectively operable in a full-bridge mode or a half-bridge mode.

5. The power converter of claim 1, wherein the N bridge circuits are N half-bridge circuits, and respective ones of the N half-bridge circuits include a switch pair bridged to a voltage supply by an inductor and a primary winding of a respective one of the N transformers.

6. The power converter of claim 1, wherein the N+1 series diode pairs are arranged in N diode bridge circuits, and respective ones of the N diode bridge circuits include two series diode pairs that are bridged by a secondary winding of a respective one of the N transformers.

7. The power converter of claim 1, wherein the N+1 series diode pairs are arranged in N diode bridge circuits, and respective ones of N−1 of the N+1 series diode pairs are common to two of the N diode bridge circuits.

8. The power converter of claim 1, wherein respective ones of the N bridge circuits include one or more switch pairs, and the DC-DC converter comprises control circuitry to control switching of the one or more switch pairs to cause the power inverter to convert the DC input to the AC output.

9. The power converter of claim 8, wherein the control circuitry includes pulse-width modulation (PWM) control circuitry to generate PWM signals to drive the one or more switch pairs of the respective ones of the N bridge circuits.

10. The power converter of claim 9, wherein the control circuitry is to adjust the PWM signals to achieve zero-voltage switching of the one or more switch pairs of the respective ones of the N bridge circuits.

11. A method comprising:
applying a direct current (DC) input to a power converter comprising a power inverter including N bridge circuits connected in parallel, where N>1, a rectifier circuit including N+1 series diode pairs connected in parallel, and an isolation transformer circuit including N transformers, respective ones of the N transformers coupled to one of the N bridge circuits and two of the N+1 series diode pairs;
converting the DC input to an alternating current (AC) output by the power inverter;
transferring the AC output from the power inverter to the rectifier circuit by the isolation transformer circuit; and
converting the AC output to a DC output by the rectifier circuit.

12. The method of claim 11, wherein the DC input is applied to the power converter in which the N bridge circuits include a bridge circuit n, the N+1 series diode pairs include series diode pairs n and n+1, and the N transformers include a transformer n coupled to and between the bridge circuit n and the series diode pairs n and n+1.

13. The method of claim 11, wherein the DC input is converted to the AC output by the power inverter in which the N bridge circuits are N full-bridge circuits, and respective ones of the N full-bridge circuits include two switch pairs that are bridged by a primary winding of a respective one of the N transformers.

14. The method of claim 13, wherein the DC input is converted to the AC output by the power inverter in which the respective ones of the N full-bridge circuits include a DC blocking capacitor, and the respective ones of the N full-bridge circuits are selectively operable in a full-bridge mode or a half-bridge mode.

15. The method of claim 11, wherein the DC input is converted to the AC output by the power inverter in which the N bridge circuits are N half-bridge circuits, and respective ones of the N half-bridge circuits include a switch pair bridged to a voltage supply by an inductor and a primary winding of a respective one of the N transformers.

16. The method of claim 11, wherein the AC output is converted to the DC output by the rectifier circuit in which the N+1 series diode pairs are arranged in N diode bridge circuits, and respective ones of the N diode bridge circuits include two series diode pairs that are bridged by a secondary winding of a respective one of the N transformers.

17. The method of claim 11, wherein the AC output is converted to the DC output by the rectifier circuit in which the N+1 series diode pairs are arranged in N diode bridge circuits, and respective ones of N−1 of the N+1 series diode pairs are common to two of the N diode bridge circuits.

18. The method of claim 11, wherein respective ones of the N bridge circuits include one or more switch pairs, and converting the DC input to the AC output includes controlling switching of the one or more switch pairs to cause the power inverter to convert the DC input to the AC output.

19. The method of claim 18, wherein controlling the switching of the one or more switch pairs includes generating pulse-width modulation (PWM) signals to drive the one or more switch pairs of the respective ones of the N bridge circuits.

20. The method of claim 19, wherein generating the PWM signals includes adjusting the PWM signals to achieve zero-voltage switching of the one or more switch pairs of the respective ones of the N bridge circuits.
